(19) United States
(12) Patent Application Publication
(10) Pub. No.: US 2015/0076826 A1
(43) Pub. Date: Mar. 19, 2015

(54) METHOD AND SYSTEM FOR GENERATING GREEN ENERGY FROM A TIDAL BODY OF WATER

(71) Applicant: Qussay Abdulatteef Jasim Al-Ani, Manama (BH)

(72) Inventor: Qussay Abdulatteef Jasim Al-Ani, Manama (BH)

(21) Appl. No.: 14/028,037

(22) Filed: Sep. 16, 2013

(51) Int. Cl. F03B 13/26; F03B 13/10

(52) U.S. Cl. CPC F03B 13/262; F03B 13/10
USPC 290/53; 60/639

(57) ABSTRACT

A system and method are providing for generating green energy from a tidal body of water. When a first arm is in a raised position and a second arm is in a lowered position, a valve in the bottom of a tank at approximately high tide level opens to fill a first container on the end of the first arm and a valve in the bottom of a second container on the second arm opens to empty the second container. When the first container is full and the second container is empty, the first arm falls and the second arm rises. Another valve in the bottom of the tank opens to fill the second container and a valve in the bottom of the first container opens to empty the first container. The arms are connected to a crankshaft to power a device.

### TECHNICAL FIELD OF THE DISCLOSURE

The present invention describes methods and apparatuses for producing green energy using the weight of water from a tidal body of water by the fast filling and emptying of a plurality of containers to pressurize the fluid in the plurality of cylinders, to thereby rotate a crank shaft of engines to generate green energy.

### BACKGROUND OF THE INVENTION

The notion of harnessing the power of ocean waves to produce energy has held mankind's fascination for quite some time, especially in light of the cost and pollution derived from the use of fossil fuels. This has resulted in several inventions directed towards converting the kinetic energy of waves into electrical energy.

A large amount of electricity is generated from fossil fuels but these fuels are not renewable and the generation process causes significant environmental pollution. Environmentally friendly ways of generating electricity include harnessing the power of the wind, using solar energy, and harnessing the power of the sea. The energy of the sun can be captured by solar panels. However generating electricity from solar panels generally requires many small-scale power generators to produce a significant amount of electricity entailing high costs. Solar energy cells are very unreliable because of night stops and the efficiency drops significantly when the sun is not shining on them. The glass covers of the cells can require continuous cleaning to ensure the efficient collection of solar rays. Replacing the panels due to breakage caused by high winds, hail, etc. adds to the cost of using solar power.

One way of generating power from the sea is to use the waves to oscillate floating buoys wherein the oscillation of the buoys is used to drive generators. Another way involves using waves to drive hydraulic rams in floating cylinders. The rams pump oil through hydraulic motors which drive generators inside the cylinders. An additional way involves having oscillating seawater in a column. When the sea rises, it pushes air or another fluid in the column above it and this movement of fluid drives an electrical generator at the top of the column.

These existing systems are small scale, requiring large numbers of them to produce a significant amount of electricity. Another way of generating power from the sea uses a wave-focusing system and hydroelectric power dams wherein waves breaking on the shore are channeled through a plurality of channels into a reservoir. As the water flows back out of the reservoir, the water drives generators connected within the channels. All of the above systems generate power in real time and not necessarily when the power is required.

Another apparatus for harnessing wave energy comprises a floating frame, a base portion connected to the floating frame and at least two linkage units. The two linkage units are a basic linkage unit and a medium linkage unit. The apparatus includes a plurality of floating flaps and at least one power extraction means. A connecting pivot is provided in the linkage units and the base portion. The floating flaps are pivoted vertically on the basic linkage unit and the base portion. The flaps associated with the floating flaps are placed under water against prevailing waves and floats associated with the floating flaps are placed on surface of the water, for absorbing the wave energy from projected portions present at edges and middle portion of the flaps.

In still another method and device for generating electric power from ocean waves, the device includes at least one magnetostrictive element and at least one buoy. When the buoy is deployed in a body of liquid subject to wave motion, the buoy remains partially submerged during normal wave motion. The buoy is coupled to the magnetostrictive element to continuously exert a varying force on the magnetostrictive element during the normal wave motion.

Therefore, there is a need for a method and apparatus that can overcome the above mentioned problems such as pollution of environment, availability of resource and cost/efficiency of production.

### SUMMARY OF THE INVENTION

The present invention provides system for generating green energy from a tidal body of water. The system comprises a tank located at approximately a high tide level and configured to receive and be filled with sea water when the tide is high; first and second normally-closed tank valves in the bottom of the tank; a reservoir located at approximately a low tide level; first and second cantilever arms located below the tank and above the reservoir, each cantilever arms connected at an inner end to a crankshaft configured to power a device, the first and second cantilever arms are pivotal between a raised position and a lowered position such that when the first cantilever arm is in the raised position, the second cantilever arm is in the lowered position; a first container secured to an outer end of the first cantilever arm and a second container secured to an outer end of the second cantilever arm, the first and second containers positioned under the first and second tank valves, respectively; and first and second normally-closed container valves in the bottom of the first and second containers, respectively. When the first cantilever arm is in the raised position, the first tank valve is opened and allows water to flow out of the tank into the first container and simultaneously the second cantilever arm is in the lowered position, the second container valve is opened and allows water to flow out of the second container into the reservoir. When the first container is filled to a predetermined level and the second container is empty, the first cantilever arm moves to the lowered position and the second cantilever arm moves to the raised position. When the second cantilever arm is in the raised position, the second tank valve is opened and allows water to flow out of the tank into the second container and simultaneously the first cantilever arm is in the lowered position, the first container valve is opened and allows water to flow out of the first container into the reservoir. And, when the second container is filled to a predetermined level and the first container is empty, the second cantilever arm moves to the lowered position and the first cantilever arm moves to the raised position. The raising and lowering of the first and second cantilever arms drives the crankshaft, thereby powering the device.

The present invention also provides a method for generating green energy by pressurizing fluid from a tidal body of water. The method comprises providing a system comprising a tank located at approximately a high tide level and configured to receive and be filled with sea water when the tide is high; first and second normally-closed tank valves in the bottom of the tank; a reservoir located at approximately a low tide level; first and second cantilever arms located below the tank and above the reservoir, each cantilever arms connected at an inner end to a crankshaft configured to power a device, the first and second cantilever arms are pivotal between a raised position and a lowered position such that when the first cantilever arm is in the raised position, the second cantilever arm is in the lowered position; a first container secured to an outer end of the first cantilever arm and a second container secured to an outer end of the second cantilever arm, the first and second containers positioned under the first and second tank valves, respectively; and first and second normally-closed container valves in the bottom of the first and second containers, respectively. The method further comprises opening the first tank valve when the first cantilever arm is in the raised position to allow water to flow out of the tank into the first container and simultaneously opening the second container valve to allow water to flow out of the second container into the reservoir the second cantilever arm is in the lowered position; allowing the first cantilever arm to move to the lowered position and the second cantilever arm to move to the raised position when the first container is filled to a predetermined level and the second container is empty; opening the second tank valve to allow water to flow out of the tank into the second container when the second cantilever arm is in the raised position and simultaneously opening the first container valve when the first cantilever arm is in the lowered position to allow water to flow out of the first container into the reservoir; and moving the second cantilever arm to the lowered position and the moving first cantilever arm to the raised position when the second container is filled to a predetermined level and the first container is empty. The raising and lowering of the first and second cantilever arms drives the crankshaft, thereby powering the device.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry may not be depicted in order to provide a clear view of the various embodiments of the invention; thus the drawings are generalized in form in the interest of clarity and conciseness.

FIG. 1 is a schematic view of an embodiment of a system for generating green energy from a tidal body of water of the present invention;

FIG. 2 is an end perspective view of the system for generating green energy of FIG. 1.

FIG. 3 is a perspective view of reservoirs that may be used in the system for generating green energy of FIG. 1; and

FIGS. 4A-4B illustrate a flow chart of a method of operation of the system for generating green energy of FIG. 1.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. Embodiments of the present invention will now be described, by way of example, with reference to the accompanying drawings. While particular embodiments have been described, it will be understood that various modifications may be made without departing from the scope of the invention.

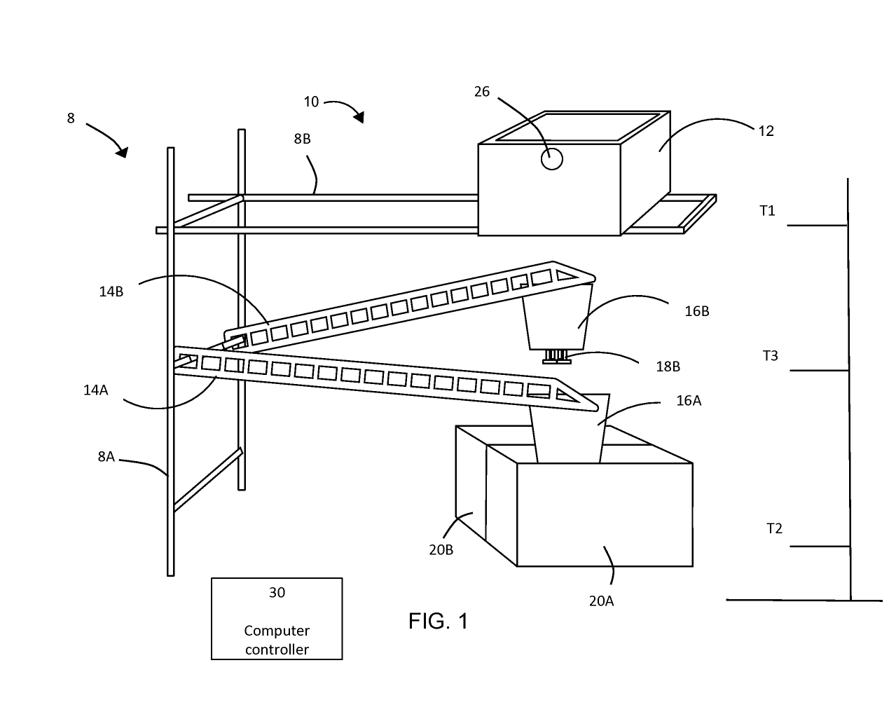

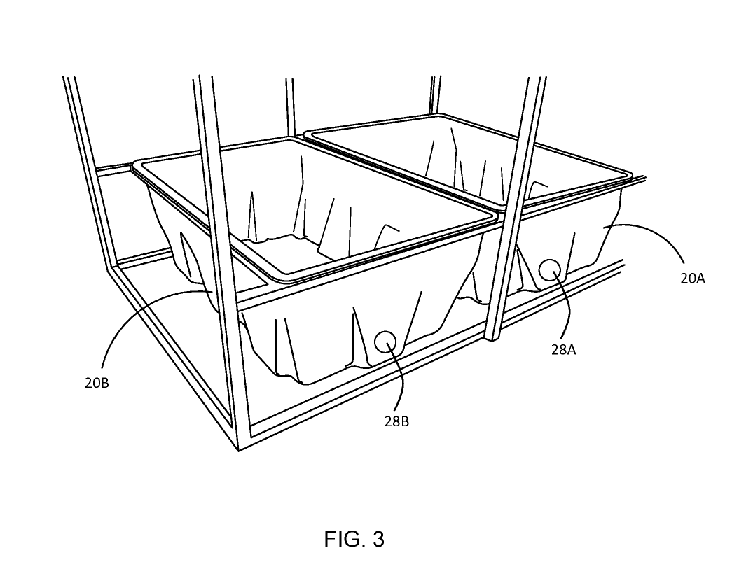

FIG. 1 is schematic view of a system 10 for generating green energy from a tidal body of water. The system 10 includes a frame 8 having a vertical section 8A and a horizontal section 8B, one end of which (the inner end) is connected to the vertical section 8A near the top of the vertical section 8A at approximately a high tide level T1. A tank 12 is secured to the outer end of the horizontal section 8B (that is, the end of the horizontal section 8B opposite the inner end). Two or more horizontally spaced-apart cantilever arms 14A, 14B are pivotally connected at their inner ends to the vertical section 8A of the frame 8 at an intermediary height T3. A container 16A, 16B is secured to an outer end of each cantilever arm 16A, 16B. The length of each cantilever arm 14 is such that the containers 16A, 16B are positioned beneath the tank 12. A normally-closed, spring-loaded or piston-driven, one-way valve 18A is located in the bottom of the container 16A (a similar valve is located in the bottom of the other container 16B but not shown in the FIGs.). A reservoir 20A, 20B (see also FIG. 3) is located beneath each container 16A, 16B at approximately a low tide level T2. (Alternatively, a single reservoir may be located under both containers 16A, 16B.) As illustrated in FIG. 1, the tank 12, containers 16A, 16B, and reservoirs 20A, 20B are vertically aligned with each other. The containers 16A, 16B may be fabricated from any of a number of water resistant materials, including fiberglass and stainless steel.

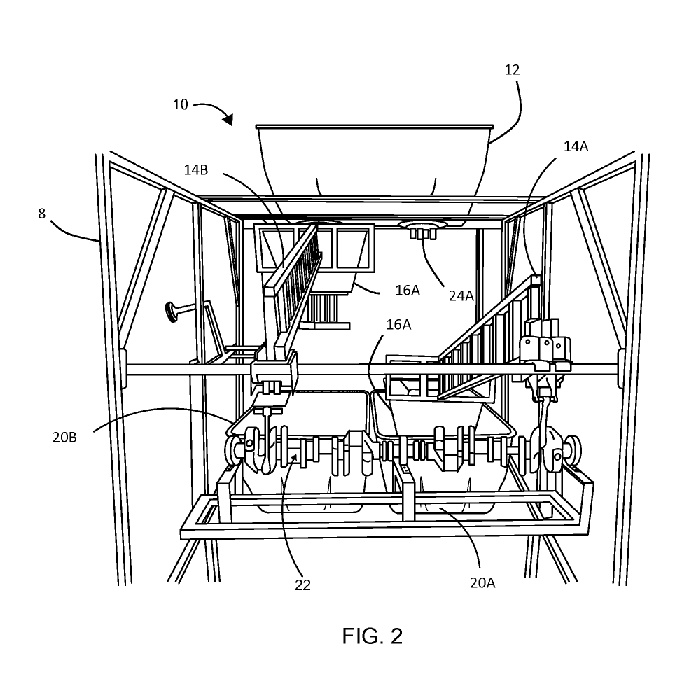

FIG. 2 is an end perspective view illustrating further details of the system 10. The cantilever arms 14A, 14B are supported on a shaft and connected through appropriate linkages to a crankshaft 22 in such a way that when one of the cantilever arms is in a raised position (the left cantilever arm 14A in FIG. 2) with its container 16A against the bottom of the tank 12, the other is in a lowered position (the right cantilever arm 14B in FIG. 2) with its container 16B in the corresponding reservoir 20B.

When a cantilever arm, such as the left arm 14B, is in the raised position, as illustrated in FIG. 2, a normally-closed, spring-loaded or piston-driven valve (not shown) in the bottom of the tank 12 is pushed into an open position. Similarly, when the other cantilever arm 14A, is in the raised position, another spring-loaded or piston-driven, one-way valve 24A (FIG. 2) in the bottom of the tank 12 is pushed into an open position. When a cantilever arm, such as the right arm 14A, is in the lowered position, as illustrated in FIG. 2, the valve (not shown) in the bottom of the container 16A is pushed into an open position. Similarly, when the other cantilever arm 14B, is in the lowered position, the valve 18B (FIG. 1) in the bottom of the container 16B is pushed into an open position.

In operation, at high tide (level T1) a one-way valve 26 in the tank 12 opens to the sea and fills with sea water. With one of the cantilever arms, such as the left arm 14B, in the raised position, the corresponding valve in the bottom of the tank 12 is open and allows water to flow from the tank 12 into the container 16B on the end of the cantilever arm 14B. A counter-weight (not shown) may be used to keep the arm 14B in the raised position until it has filled with water to a predetermined level. The other cantilever arm 14A is in its lowered position and the container 16A on the end of the arm 14A is empty. The full container 16B outweighs the empty container 16A; gravity causes the full container 16B to overcome the counterweight and fall to its lowered position and the empty container 16A to rise to its raised position. When the full container 16B is in its lowered position, the valve 18B in its bottom is pressed open against its spring, allowing water to flow out through the valve into the reservoir 20B. Simultaneously, when the empty container 16A has risen to its raised position, the valve 24A in the bottom of the tank 12 is pressed open against its spring, allowing water to flow out through the valve 24A into the previously empty container 16A.

Next, with the right cantilever arm 14A in the raised position, the corresponding valve 24A in the bottom of the tank 12 is open and allows water to flow from the tank 12 into the empty container 16A on the end of the cantilever arm 14A. A counter-weight (not shown) may be used to keep the arm 14A in the raised position until it has filled with water to a predetermined level. The other cantilever arm 14B is in its lowered position and the container 16B on the end of the left arm 14B has emptied. The newly filled container 16A outweighs the now empty container 16B; gravity causes the full container 16A to overcome the counterweight and fall to its lowered position and the empty container 16B to rise to its raised position. When the full container 16A is in its lowered position, the valve in its bottom is pressed open, allowing water to flow out through the valve into the reservoir 20A. Simultaneously, when the empty container 16B has risen to its raised position, the valve 24A in the bottom of the tank 12 is pressed open, allowing water to flow out through the valve 24A into the previously empty container 16B. When the reservoirs 20A, 20B are full, water is allowed to flow out of them through one-way output valves 28A, 28B.

In addition to installing the system 10 to take advantage of the rising and falling tides of the sea, the system 10 may be installed to take advantage of rising and falling of any other body of water or fluid.

As the cantilever arms 14A, 14B rise and fall as their corresponding containers 16A, 16B empty and fill, the attached crankshaft 22 is turned and is available to power any device connected to the crankshaft 22, such as an electrical generator used to directly provide power or to charge batteries, pump, desalinator, and other mechanically or electrically powered device. In one embodiment, the cantilever arms 14A, 14B and crankshaft 22 are configured such that one complete cycle rising and falling of the right and left cantilever arms 14A, 14B causes the crankshaft 22 to make one complete rotation.

It will be appreciated that the cantilever arms 14A, 14B may be connected using means other than, or in addition to, the illustrated crankshaft 22. For example, gears or pulleys and chains/ropes may be used to reduce the amount of water needed by providing a mechanical advantage. The cantilever arms 14A, 14B may also be on opposite sides of the vertical section 8A of the frame 8. The cantilever arms 14A, 14B may also be connected to hydraulic pistons which may use fluid, such as oil, to pressurize other pistons and, using the resulting mechanical advantage, drive other devices such as, for example, reverse osmosis desalinators, rotary engines, impulse turbines, hydrogen liquefiers, petroleum gas liquefiers, to name a few. Among other uses, the liquefied gas may be used in an air conditioning unit.

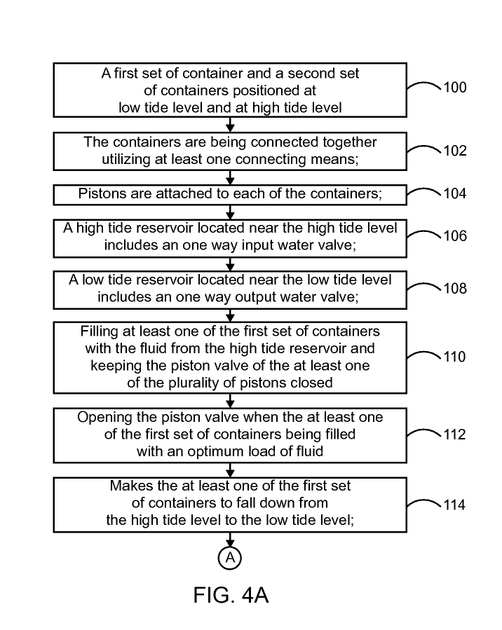

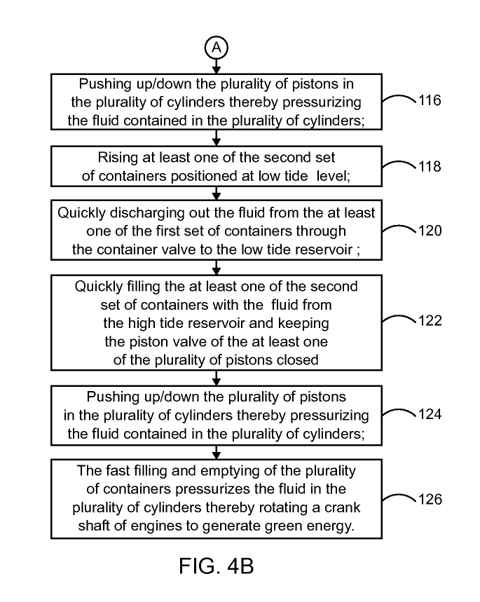

It will also be appreciated that, although the FIGs. show only a single set of cantilever arms 14A, 14B, containers 16A, 16B, and associated valves, the system 10 may be expanded to include more than one set connected through linkages to the crankshaft 22 for a greater mechanical power output. Accordingly, the flow chart of FIGS. 4A-4B is described in terms of multiple sets of cantilever arms, containers, and valves. However, the same element numbers will be used as were used in the description above of the individual components.

FIGS. 4A-4B are a flow chart illustrating a method of the system 10 for generating green energy from a tidal body of water. In step 100, a first set of containers 16A and a second set of containers 16B are positioned in a frame 8 at a low tide level T2 and at a high tide level T1, respectively. In step 102, the containers 16A, 16B are being connected together utilizing at least one connecting means, such as linkages to a crankshaft 22. In step 104, pistons are attached to each of the containers 16A, 16B. In step 106, a high tide tank 12 located near the high tide level T1 includes a one way input water valve. In step 108, a low tide reservoir 20 located near the low tide level T2 includes a one way output water valve. In step 110, the first set of containers 16A is filled with the water from the high tide tank 12 while piston valves of the pistons connected to the containers 16A remain closed. In step 112, the piston valves are opened when the first set of containers 16A has filled to a predetermined level of water.

In step 114, the first set of containers 16A will fall down from the high tide level T1 to the low tide level T2. In step 116, the pistons in the cylinders are pushed up and down, thereby pressurizing the fluid contained the cylinders. In step 118, the second set of containers 16B is positioned at the low tide level T2. In step 120, water is quickly discharge from the first set of containers 16A through the container valve into the low tide reservoir 20. In step 122, the second set of containers 16B is quickly filled with the water from the high tide tank 12 while the piston valve of the pistons remain closed. In step 124, the pistons in the cylinders are pushed up and down, thereby pressurizing the water contained in the plurality of cylinders. In step 126, the fast filling and emptying of the containers 16A, 16B pressurizes the fluid in the cylinders whereby the crankshaft 22 is rotated to generate green energy to be coupled to other devices.

As an alternative to the cantilever arms 14A, 14B being connected to the crankshaft 22, they may be connected to hydraulic pistons and pressurize each piston on a down stroke of an arm. In either embodiment, the system 10 employs the weight of water or fluid in the containers 16A, 16B to generate a large mechanical force through leveraging or other force multipliers and drive other devices. The pistons may be connected to the cantilever arms 14A, 14B at any appropriate location along the arms 14A, 14B, depending on the force and the necessary vertical travel requirements.

For advanced control of the components, a computer controller 30 may be integrated into the system 10 to coordinate and monitor the operation of the valves 18A, 18B, 24, 26, 28A, 28B, and other components.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A system for generating green energy from a tidal body of water, the system comprising:
a tank located at approximately a high tide level and configured to receive and be filled with sea water when the tide is high;
first and second normally-closed tank valves in the bottom of the tank;
a reservoir located at approximately a low tide level;
first and second cantilever arms located below the tank and above the reservoir, each cantilever arms connected at an inner end to a crankshaft configured to power a device, the first and second cantilever arms are pivotal between a raised position and a lowered position such that when the first cantilever arm is in the raised position, the second cantilever arm is in the lowered position;
a first container secured to an outer end of the first cantilever arm and a second container secured to an outer end of the second cantilever arm, the first and second containers positioned under the first and second tank valves, respectively; and
first and second normally-closed container valves in the bottom of the first and second containers, respectively;
whereby:
when the first cantilever arm is in the raised position, the first tank valve is opened and allows water to flow out of the tank into the first container and simultaneously the second cantilever arm is in the lowered position, the second container valve is opened and allows water to flow out of the second container into the reservoir;
when the first container is filled to a predetermined level and the second container is empty, the first cantilever arm moves to the lowered position and the second cantilever arm moves to the raised position;
when the second cantilever arm is in the raised position, the second tank valve is opened and allows water to flow out of the tank into the second container and simultaneously the first cantilever arm is in the lowered position, the first container valve is opened and allows water to flow out of the first container into the reservoir; and
when the second container is filled to a predetermined level and the first container is empty, the second cantilever arm moves to the lowered position and the first cantilever arm moves to the raised position; and
whereby the raising and lowering of the first and second cantilever arms drives the crankshaft, thereby powering the device.

2. The system of claim 1 further comprising a plurality of cylinders having a plurality of pistons, each of the plurality of pistons having a piston valve, at least one of the plurality of pistons being attached to each of the containers.

3. The system of claim 2 wherein the pistons in the cylinders pressurize a fluid driving a device selected from the group consisting of a device to liquefy hydrogen, a device to liquefy petroleum gas, and a device to produce potable water by reverse osmosis.

4. The system of claim 2 wherein, while each of the first and second containers is filled with the water from the tank, the piston valve of the associated piston remains closed.

5. The system of claim 2 wherein the associated piston valve is opened when the container is filled to a predetermined level, the container falls from the first level to the second level.

6. The system of claim 2 wherein as first and second cantilever arms are raised and lowered, the pistons are pushed up and down in the plurality of cylinders and pressurize a fluid contained in the plurality of cylinders.

7. The system of claim 6 wherein the plurality of cylinders receive the fluid from a source other than the first and second containers.

8. The system of claim 1 wherein the first and second cantilever arms are connected to the crankshaft by a linkage selected from a group consisting of gears, chains, and ropes.

9. The system of claim 1 wherein the cantilever arms and crankshaft are configured such that one complete cycle rising and falling of the cantilever arms causes the crankshaft to make one complete rotation.

10. The system of claim 1 wherein the first and second containers utilize a controlling means to control the flow of pressurized tidal body of water.

11. The system of claim 1 wherein the first and second cantilever arms are connected to the crankshaft on opposite sides of a frame.

12. The system of claim 1 wherein the first and second cantilever arms are connected to the crankshaft on the same side of a frame.

13. The system of claim 1 wherein the first and second containers are made of a material selected from the group consisting of fiberglass, stainless steel, and other water resistant material.

14. The system of claim 1 wherein the powered device comprises an electrical generator.

15. A method for generating green energy by pressurizing fluid from a tidal body of water, the method comprising:
providing a system comprising:
a tank located at approximately a high tide level and configured to receive and be filled with sea water when the tide is high;
first and second normally-closed tank valves in the bottom of the tank;
a reservoir located at approximately a low tide level;
first and second cantilever arms located below the tank and above the reservoir, each cantilever arms connected at an inner end to a crankshaft configured to power a device, the first and second cantilever arms are pivotal between a raised position and a lowered position such that when the first cantilever arm is in the raised position, the second cantilever arm is in the lowered position;
a first container secured to an outer end of the first cantilever arm and a second container secured to an outer end of the second cantilever arm, the first and second containers positioned under the first and second tank valves, respectively; and
first and second normally-closed container valves in the bottom of the first and second containers, respectively;
opening the first tank valve when the first cantilever arm is in the raised position to allow water to flow out of the tank into the first container and simultaneously opening the second container valve to allow water to flow out of the second container into the reservoir the second cantilever arm is in the lowered position;
allowing the first cantilever arm to move to the lowered position and the second cantilever arm to move to the raised position when the first container is filled to a predetermined level and the second container is empty;
opening the second tank valve to allow water to flow out of the tank into the second container when the second cantilever arm is in the raised position and simultaneously opening the first container valve when the first cantilever arm is in the lowered position to allow water to flow out of the first container into the reservoir; and
moving the second cantilever arm to the lowered position and the moving first cantilever arm to the raised position when the second container is filled to a predetermined level and the first container is empty;
whereby the raising and lowering of the first and second cantilever arms drives the crankshaft, thereby powering the device.

16. The method of claim 15 wherein the first and second cantilever arms are connected to the crankshaft by a linkage selected from a group consisting of gears, chains, and ropes.

17. The method of claim 15 further comprising using a computer controller to control operation of the first and second tank valves and first and second container valves.
